(19) United States
(12) Patent Application Publication
(10) Pub. No.: US 2026/0199861 A1
(43) Pub. Date: Jul. 16, 2026

(54) METHOD OF CATALYTICALLY PYROLYZING A METHANE-CONTAINING STREAM

(71) Applicant: SHELL USA, INC., Houston, TX (US)

(72) Inventors: Zhe CUI, Houston, TX (US); Leonardo SPANU, Houston, TX (US)

(21) Appl. No.: 19/135,769

(22) PCT Filed: Dec. 13, 2023
(86) PCT No.: PCT/EP2023/085588

§ 371 Date: Jun. 4, 2025

Related U.S. Application Data
(60) Provisional application No. 63/387,726, filed on Dec. 16, 2022.

(30) Foreign Application Priority Data
Jan. 23, 2023 (EP) 23152818.3

(51) Int. Cl. B01J 8/22; B01J 8/00; B01J 8/18; C01B 3/26; C01B 3/50; C01B 32/05

(52) U.S. Cl. CPC B01J 8/22; B01J 8/0045; B01J 8/005; B01J 8/1827; C01B 3/26; C01B 3/50; C01B 32/05; B01J 2208/00761; C01B 2203/0277; C01B 2203/04; C01B 2203/1241

(57) ABSTRACT

A method of catalytically pyrolyzing a gaseous methane-containing stream, includes feeding the stream in the form of gas bubbles into a reaction zone containing catalyst particles suspended in a molten salt and subjecting the stream to catalytic pyrolysis thereby obtaining solid carbon and gaseous hydrogen. As the molten salt, solid carbon and gaseous hydrogen are allowed to move upwards from the reaction zone to an intermediate zone, gas bubbles are broken by first bubble breakers having an open area of greater than 90%. As solid carbon, gaseous hydrogen and part of the molten salt are allowed to move further upwards from the intermediate zone to a separation zone, gas bubbles are broken by second bubble breakers.

The present invention relates to a method of catalytically pyrolyzing a methane-containing stream.

Methods for catalytically pyrolyzing a methane-containing stream are known in the art.

Examples of known methods for catalytically pyrolyzing a methane-containing stream have for example been disclosed in WO22035963A2 and WO2022058355A1 (also published as CA3194814A1).

A problem of known methods is that gas bubbles (either formed during the catalytic pyrolysis or being present in the methane-containing stream that is subjected to the catalytic pyrolysis) tend to grow (bubble coalescence) when moving up and entrain catalyst particles to areas where the catalyst particles are not desired. This may for example lead to catalyst loss and plugging of downstream filtration media or the like.

A further problem of known methods is that larger bubbles (in particular when greater than 10 mm in diameter) will generate a non-uniform flow field and may disturb any solid carbon product layer being formed in the top region (separation zone) of the reactor.

It is an object of the present invention to solve, minimize or at least reduce one or more of the above problems.

It is a further object of the present invention to provide an alternative method of catalytically pyrolyzing a methane-containing stream, in particular in the presence of molten salt.

One or more of the above or other objects may be achieved according to the present invention by providing a method of catalytically pyrolyzing a methane-containing stream, the method at least comprising the steps of:
(a) providing a gaseous methane-containing stream;
(b) feeding the gaseous methane-containing stream provided in step (a) in the form of gas bubbles into a reaction zone containing molten salt and catalyst particles, wherein the catalyst particles are suspended in the molten salt;
(c) subjecting the methane-containing stream to catalytic pyrolysis in the reaction zone thereby obtaining solid carbon and gaseous hydrogen;
(d) allowing the molten salt, solid carbon and gaseous hydrogen to move upwards from the reaction zone to an intermediate zone whilst catalyst particles are kept in the reaction zone;
(e) optionally, allowing a first part of the molten salt to flow from the intermediate zone to the reaction zone, or from an upper part of the reaction zone to a lower part of the reaction zone, via a return loop;
(f) allowing solid carbon, gaseous hydrogen and a second part of the molten salt to move further upwards from the intermediate zone to a separation zone;
(g) removing solid carbon and gaseous hydrogen from the separation zone by gas entrainment using an inverted funnel;

wherein gas bubbles are broken by first bubble breakers having an open area of greater than 90% when the molten salt, solid carbon and gaseous hydrogen are moving upwards in step (d) from the reaction zone to the intermediate zone; and

wherein gas bubbles are broken by second bubble breakers when the molten salt, solid carbon and gaseous hydrogen are moving upwards in step (f) from the intermediate zone to the separation zone.

It has surprisingly been found according to the present invention that by using first bubble breakers it can be arranged in a surprisingly simple manner that molten salt, solid carbon and gaseous hydrogen are allowed to move upwards from the reaction zone to an intermediate zone, whilst catalyst particles are kept in the reaction zone. This avoids e.g. catalyst loss and the plugging of downstream facilities such as filters and the like by the catalyst particles.

A further advantage of the method according to the present invention is that because larger bubbles (preferably having a size of at least 10 mm in diameter) are broken by the first bubble breakers into smaller bubbles (preferably having a size of at most 6 mm), the flow field in the separation zone is much more uniform, avoiding the disturbance of a carbon product layer being formed in the separation zone.

A further advantage is that the second bubble breakers provide that larger (preferably at least 10 mm in diameter) gas bubbles are broken when the molten salt, solid carbon and gaseous hydrogen are moving upwards in step (f) from the intermediate zone to the separation zone. These second bubble breakers can help to minimize the disturbance of the solid carbon layer and the back-mixing of the solid carbon with molten salt in the intermediate zone.

In this respect it is acknowledged that bubble breakers are known per se in the art (see e.g. the article by A. H. Gadallah et al. in Chemical Engineering Sciences 131 (2015) 22-40). However, such bubble breakers have not been proposed for use in catalytic pyrolysis of methane-containing streams in the presence of molten salt, let alone as the first and second bubble breakers in the specific set-up of the method according to the present invention.

In step (a) of the method according to the present invention, a gaseous methane-containing stream is provided.

Although the gaseous methane-containing stream as provided in step (a) is not particularly limited, and typically is natural gas or other methane-containing process gas, it preferably comprises at least 70 vol. % methane, preferably at least 90 vol. % methane. Some other light (C2-C5) hydrocarbons and hydrogen may be present as well. In case hydrogen is present, then hydrogen is preferably present in an amount of at most 15.0 vol. %.

In step (b) of the method according to the present invention, the gaseous methane-containing stream provided in step (a) is fed in the form of gas bubbles into a reaction zone containing molten salt and catalyst particles, wherein the catalyst particles are suspended in the molten salt.

Usually, the gaseous methane-containing stream is fed at or near the bottom of the reaction zone using a gas distributor such as a sparger or the like to distribute the methane-containing stream evenly across the cross section of the reaction zone. Typically, the reaction zone is placed in a bottom part of a vessel.

Preferably, the gaseous methane-containing stream is fed at a flux of from 0.7 kg/m²/min to 20.0 kg/m²/min, preferably from 1.4 kg/m²/min to 5.0 kg/m²/min.

The person skilled in the art will readily understand that the molten salt is not particularly limited and can be selected from a wide variety of molten salts such as NaCl, KCl , CaCl₂, MgCl₂, NaNO₃, KNO₃, Ca(NO₃)₂, Mg(NO₃)₂ Or mixtures of these salts. Preferably, the molten salt is selected from the group consisting of NaCl, KCl, CaCl₂, NaNO₃, KNO₃, Ca(NO₃)₂, more preferably NaCl, KCl. It is especially preferred that the molten salt has a melting point or range that lies between 500-800° C.

Suitably, the molten salt has a density that is (at least slightly) lower than the density of the catalyst particles. Preferably, the molten salt has a density of from 1000 kg/m₃ to 3000 kg/m³, preferably from 1200 kg/m³ to 2000 kg/m³.

The person skilled in the art will also readily understand that the catalyst particles are not particularly limited.

Preferably, the catalyst particles are selected from SiC, SiO₂, Al₂O₃, activated carbon, ceramics, etc. A mixture of materials may be used. Other catalysts (and supports) may also be used to provide suitable hydrodynamics properties (density, diameter, porosity, etc.).

Suitably, to be suspended in the molten salt medium, the catalyst particles have a density that is close to or (at least slightly) higher than the density of the molten salt. Preferably, the catalyst particles have a density of from 1000 kg/m³ to 3800 kg/m³, preferably from 1400 kg/m³ to 1800 kg/m³; the density will be selected based on the molten salt used. Further it is preferred that the catalyst particles have an average size of 0.6 to 6.0 mm in diameter, more preferably from 0.8 to 4.0 mm in diameter.

As mentioned above, the catalyst particles are ‘suspended’ in the molten salt. In other words, the catalyst particles will have a density selected to allow the catalyst particles to suspend in the molten salt under the pyrolysis conditions (rather than float upwards which would be the case if the catalyst particles would have a density that would be lower than the density of the molten salt).

In step (c) of the method according to the present invention, the methane-containing stream is subjected to catalytic pyrolysis in the reaction zone thereby obtaining solid carbon and gaseous hydrogen.

As the person skilled in the art is familiar with catalytic pyrolysis in the presence of molten salt, this is not discussed here in detail.

Typically, the catalytic pyrolysis takes place in the reaction zone at temperatures of from 600° C. to 1000° C., preferably from 850° C. to 950° C. and at pressures of from 1.0 bara to 10.0 bara.

Preferably, the height of the reaction zone (with catalyst particles suspended in the molten salt) is from 0.5 m to 3.0 m, more preferably from 1.0 to 2.0 m.

In step (d) of the method according to the present invention, the molten salt, solid carbon and gaseous hydrogen are allowed to move upwards from the reaction zone to an intermediate zone whilst catalyst particles are kept in the reaction zone.

The intermediate zone is typically placed above the reaction zone and may form part of the same or a separate vessel.

The moving up of the molten salt, solid carbon and gaseous hydrogen (and possibly unreacted methane) is typically caused by one or more of density difference (with the catalyst particles), the circular flow of molten salt and the upwards movement of gas bubbles (either formed during the catalytic pyrolysis or being present in the methane-containing stream that is subjected to the catalytic pyrolysis). Also, a pump may be used to assist in driving the upwards flow of the molten salt, solid carbon and gaseous hydrogen. In case a pump is used, then it is typically located externally. Preferably, the flux of the molten salt circulation is from 5.0 kg/m²/s to 130.0 kg/m²/s, preferably from 35.0 kg/m²/s to 75.0 kg/m²/s.

An important aspect of the present invention is that larger (preferably, at least 10 mm in diameter) gas bubbles are broken by the first bubble breakers when the molten salt, solid carbon and gaseous hydrogen are moving upwards in step (d) from the reaction zone to the intermediate zone. This avoids or at least minimizes that catalyst particles are entrained with such gas bubbles and move upwards together with the molten salt, solid carbon and gaseous hydrogen from the reaction zone to the intermediate zone. Preferably, the bubble breakers break (larger) gas bubbles that have a size of at least 10 mm in diameter to smaller gas bubbles (preferably at most 6 mm in diameter).

As bubble breakers are known in the art as such (even though they have not been proposed for use in catalytic pyrolysis of methane-containing streams in the presence of molten salt), they are not further discussed here in detail. Suitable bubble breakers can be mesh type, honeycomb monolith type, sieve trays or may be in the form of vertically extending plates, filters, etc. The bubble breakers may have a grid structure.

Preferably, the first and second bubble breakers are in the form of vertically extending plates or filters.

Preferably, the first bubble breakers are fully submerged in molten salt.

The first bubble breakers have an open area of >90% to provide only a low pressure drop (thereby allowing a free upward flow of molten salt, solid carbon and gaseous hydrogen).

Further it is preferred that the second bubble breakers are only partially submerged in molten salt. Preferably, the second bubble breakers have an open area of from 70 to 90%. This allows for a higher pressure drop and helps to constrain the molten salt below the second bubble breaker and minimize the disturbance of the solid carbon layer formed during use.

In step (e) of the method according to the present invention, a first part of the molten salt is allowed to flow (down) from the intermediate zone to the reaction zone, or from an upper part of the reaction zone to a lower part of the reaction zone, via a return loop. This provides for or at least assists in the circular flow of molten salt as mentioned above. Preferably, there is at least a return loop between the intermediate zone and the reaction zone.

This return loop may (in case the reaction zone and the intermediate zone are part of the same vessel) be placed inside the vessel, but is preferably located outside the vessel.

In step (f) of the method according to the present invention, solid carbon, gaseous hydrogen (and any unreacted methane) and a second part of the molten salt is allowed to move further upwards from the intermediate zone to a separation zone.

The separation zone is typically placed above the intermediate zone and may form part of the same vessel as the reaction zone and the intermediate zone.

In the (top) separation zone separation takes place; due to density differences (between solid carbon and molten salt), a molten salt-depleted (or even molten salt-free) top layer of solid carbon will form in the separation zone (on top of molten salt).

As mentioned above, larger (preferably at least 10 mm in diameter) gas bubbles are broken by the second bubble breakers when the molten salt, solid carbon and gaseous hydrogen are moving upwards in step (f) from the intermediate zone to the separation zone. These second bubble breakers can help to minimize the disturbance of to the solid carbon layer and the back-mixing of the solid carbon with molten salt in the intermediate zone.

In step (g) of the method according to the present invention, solid carbon and gaseous hydrogen (and any unreacted methane) are removed from the separation zone. The solid carbon product, after possible to remove any remaining salt in the carbon, can be used as a raw material to produce color pigments, fibers, foil, cables, activated carbon or tires. In addition, the solid carbon product may be mixed with other materials to modify the mechanical, thermal and/or electric properties of those materials.

The person skilled in the art will readily understand that the solid carbon and gaseous hydrogen can be removed in various ways.

According to the present invention, in step (g) solid carbon and gaseous hydrogen are removed from the separation zone by gas entrainment, using an inverted funnel. Preferably, to provide a higher gas velocity and to assist in the gas entrainment, supplemental gas is fed to the separation zone. This supplemental gas is typically fed via a separate inlet. Preferably, the supplemental gas is selected from inert gas or a recycled gas stream (e.g. coming from a gas/liquid separator), preferably a recycled gas stream.

Additionally, in step g) part of the solid carbon and gaseous hydrogen can be removed from the separation zone by a screw conveyor. As screw conveyors are known in the art as such, these are not further discussed here in detail.

In a further aspect the present invention provides an apparatus for catalytically pyrolyzing a methane-containing stream, the apparatus at least comprising:
a reaction zone containing molten salt and catalyst particles, wherein during use a methane-containing stream can be fed into the reaction zone in the form of gas bubbles and the catalyst particles can be suspended in the molten salt, and wherein during use the methane-containing stream can be subjected to catalytic pyrolysis in the reaction zone thereby obtaining solid carbon and gaseous hydrogen;
an intermediate zone for receiving molten salt, solid carbon and gaseous hydrogen that during use have moved upwards from the reaction zone to the intermediate zone whilst catalyst particles are kept in the reaction zone;
optionally, a return loop for allowing a first part of the molten salt to flow from the intermediate zone to the reaction zone, or from an upper part of the reaction zone to a lower part of the reaction zone;
a separation zone for receiving solid carbon, gaseous hydrogen and a second part of the molten salt that have moved further upwards from the intermediate zone to the separation zone, and for separating the solid carbon and gaseous hydrogen from the molten salt;
first bubble breakers placed between the reaction zone and the intermediate zone that can break (preferably larger, i.e. at least 10 mm in diameter) gas bubbles when the molten salt, solid carbon and gaseous hydrogen are moving upwards from the reaction zone to the intermediate zone, the first bubble breakers having an open area of greater than 90%;
second bubble breakers placed between the intermediate zone and the separation zone that can break (preferably larger, i.e. at least 10 mm in diameter) gas bubbles when the molten salt, solid carbon and gaseous hydrogen are moving upwards from the intermediate zone to the separation zone;
a sucker for gas entrainment for removing solid carbon and gaseous hydrogen from the separation zone, using an inverted funnel.

As mentioned above, the reaction zone, intermediate zone and separation zone may be part of the same vessel (or may be part of separate vessels). In case they are part of the same vessel, then then reaction zone is typically the bottom part and the separation zone the top part (although the vessel may comprise further parts), with the intermediate zone placed in between the reaction zone and the separation zone.

Although the first and second bubble breakers can take various shapes and forms, preferably the bubble breakers are in the form of vertically extending plates or filters.

The separation zone preferably has an inlet for feeding supplemental gas, to aid the gas entrainment from the separation zone.

According to a separate preferred embodiment, the apparatus additionally comprises a screw conveyor for removing solid carbon and gaseous hydrogen from the separation zone.

Hereinafter the present invention will be further illustrated by the following non-limiting drawings.

Herein shows:

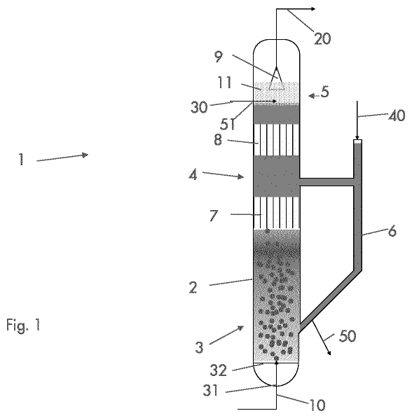

FIG. 1 schematically a first embodiment of an apparatus for catalytically pyrolyzing a methane-containing stream according to the present invention;

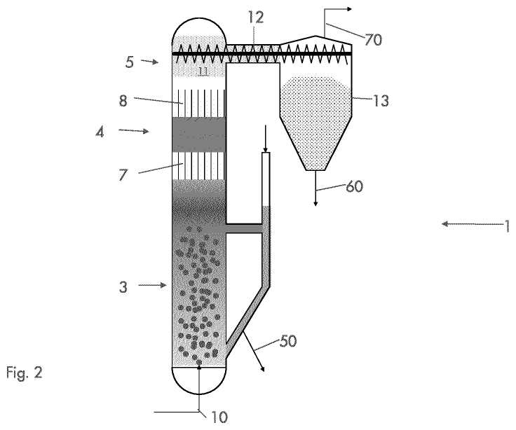

FIG. 2 schematically a second embodiment of an apparatus for catalytically pyrolyzing a methane-containing stream according to the present invention; and

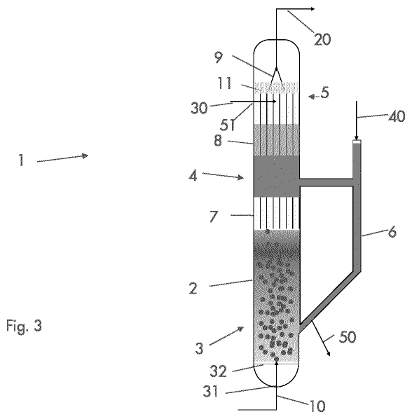

FIG. 3 schematically a third embodiment of an apparatus for catalytically pyrolyzing a methane-containing stream according to the present invention.

For the purpose of this description, same reference numbers refer to same or similar components.

The apparatus as shown in FIG. 1 generally referred to with reference number 1, shows a vessel 2 comprising: a reaction zone 3; an intermediate zone 4; a separation zone 5; a return loop 6 for molten salt; a first set of bubble breakers 7 between the reaction zone 3 and the intermediate zone 4; a second set of bubble breakers 8 between the intermediate zone 4 and the separation zone 5; and a sucker 9.

In the embodiment of FIG. 1 the reaction zone 3, intermediate zone 4 and separation zone 5 form part of one and the same vessel 2.

The reaction zone 3 contains molten salt and catalyst particles suspended therein. The reaction zone 3 comprises, at the bottom thereof, an inlet 31 connected to a gas distributor 32 (such as a sparger or the like) for feeding a methane-containing stream 10 into the reaction zone 3 in the form of gas bubbles. Usually, the sparger or the like is arranged to distribute the methane-containing stream evenly across the cross section of the reaction zone 3.

The intermediate zone 4 is placed between the reaction zone 3 and the separation zone 5.

The return loop 6 allows a first part of the molten salt to flow from the intermediate zone 4 to the reaction zone 3.

The first set of bubble breakers 7 (having an open are of greater than 90%) placed between the reaction zone 3 and the intermediate zone 4 can during use break (preferably larger, i.e. at least 10 mm in diameter) gas bubbles when the molten salt, solid carbon and gaseous hydrogen are moving upwards from the reaction zone 3 to the intermediate zone 4.

The second set of bubble breaker 8 placed between the intermediate zone 4 and the separation zone 5 can during use break (preferably larger, i.e. at least 10 mm in diameter) gas bubbles when the molten salt, solid carbon and gaseous hydrogen are moving upwards from the intermediate 4 zone to the separation zone 5. The second bubble breakers 8 typically have a smaller open area (preferably from 70 to 90%) than the first bubble breakers 7.

In the embodiment of FIG. 1, the first and second bubble breakers 7,8 are in the form of vertically extending plates.

In the embodiment of FIG. 1, the separation zone 5 comprises a sucker 9 (e. g. in the form of an inverted funnel) for removing solid carbon (which has formed during use as a layer 11 on top of the molten salt) and gaseous hydrogen from the separation zone 5 by gas entrainment. To assist the gas entrainment, the separation zone 5 has an inlet 51 for feeding supplemental gas 30.

During use of the apparatus of FIG. 1, a gaseous methane-containing stream 10 is fed (via the inlet 31 and using the gas distributor 32) in the form of gas bubbles into the reaction zone 3. The reaction zone 3 contains molten salt and catalyst particles being suspended in the molten salt.

In the reaction zone 3, the methane-containing stream is subjected (under suitable catalytic pyrolysis conditions) to catalytic pyrolysis thereby obtaining solid carbon and gaseous hydrogen.

The molten salt, solid carbon and gaseous hydrogen are allowed to move upwards from the reaction zone 3 to the intermediate zone 4, whilst catalyst particles are kept in the reaction zone 3. The moving up of the molten salt, solid carbon and gaseous hydrogen from the reaction zone 3 to the intermediate zone 4 is typically caused by one or more of density difference (with the catalyst particles), the circular flow of molten salt and the upwards movement of gas bubbles (either formed during the catalytic pyrolysis or being present in the methane-containing stream that is subjected to the catalytic pyrolysis). Also, a pump (not shown) may be used to assist in driving the upwards flow of the molten salt, solid carbon and gaseous hydrogen. In case a pump is used, then it is typically located externally of the vessel 2.

Preferably, the height of the reaction zone 3 (with catalyst particles suspended in the molten salt) is from 0.5 m to 3.0 m, more preferably from 1.0 to 2.0 m.

When the molten salt, solid carbon and gaseous hydrogen are moving upwards from the reaction zone 3 to the intermediate zone 4 (preferably larger) gas bubbles (either formed during the catalytic pyrolysis or being present in the methane-containing stream that is subjected to the catalytic pyrolysis) are broken by the first bubble breakers 7. This avoids that catalyst particles are entrained with the gas bubbles and move to the intermediate zone 4 as well.

Then, a first part of the molten salt is allowed to flow back from the intermediate zone 4 to the reaction zone 3 via the return loop 6. As shown in the embodiment of FIG. 1 supplemental molten salt 40 may be added (as shown in FIG. 1 via the return loop 6). Also shown in FIG. 1 is a flow 50 to a molten salt reservoir (not shown).

Further, solid carbon, gaseous hydrogen and a second part of the molten salt is allowed to move further upwards from the intermediate zone 4 to the separation zone 5. In the embodiment of FIG. 1 a second set of bubble breakers 8 are present to further minimize the entrainment of catalyst particles in the second part of the molten salt stream to the separation zone 5. Preferably, the second bubble breakers 8 have an open area of from 70 to 90%. This allows for a higher pressure drop and helps to constrain the molten salt below the second bubble breakers 8 and minimize the disturbance of the solid carbon layer formed during use.

Subsequently, solid carbon (which has formed during use as a layer 11 on top of the molten salt) and gaseous hydrogen from are removed from the separation zone 5, leaving the molten salt behind.

FIG. 2 shows an alternative embodiment of an apparatus 1 according to the present invention. In FIG. 2, the apparatus 1 comprises a screw conveyor 12 (connected to a hopper 13) for removing solid carbon and gaseous hydrogen from the separation zone 5, in addition to the sucker 9 (not shown in FIG. 2). The solid carbon is removed from the hopper 13 as bottom stream 60, whilst the gaseous hydrogen is removed as overhead stream 70.

Further, in the embodiment of FIG. 2 a first part of the molten salt is allowed to flow from an upper part of the reaction zone 3 to a lower part of the reaction zone 3, via the return loop 6.

FIG. 3 shows an alternative embodiment of an apparatus 1 according to the present invention. In FIG. 3, it is shown that the second bubble breakers 8 are only partially submerged in molten salt. This aids to further constrain the molten salt below the second bubble breakers 8 and minimize the disturbance of the solid carbon layer formed during use.

### DISCUSSION

As can be seen from FIGS. 1, 2 and 3, the method according to the present invention allows for a surprisingly simple and effective way of catalytically pyrolyzing a methane-containing stream.

An important aspect of the present invention is that larger (preferably at least 10 mm in diameter) gas bubbles are broken by the first bubble breakers when the molten salt, solid carbon and gaseous hydrogen are moving upwards from the reaction zone to the intermediate zone. This avoids the entrainment of catalyst particles which may hamper downstream operations. The presence of larger gas bubbles is further minimized by using the second set of bubble breakers between the intermediate zone and the separation zone. As a result, the disturbance to the solid carbon layer and the back-mixing of the solid carbon with molten salt in the intermediate zone induced by larger gas bubbles can be minimized.

The person skilled in the art will readily understand that many modifications may be made without departing from the scope of the invention. Further, the person skilled in the art will readily understand that, while the present invention in some instances may have been illustrated making reference to a specific combination of features and measures, many of those features and measures are functionally independent from other features and measures given in the respective embodiment(s) such that they can be equally or similarly applied independently in other embodiments.

1. A method of catalytically pyrolyzing a methane-containing stream, the method at least comprising the steps of:
(a) providing a gaseous methane-containing stream (10);
(b) feeding the gaseous methane-containing stream provided in step (a) in the form of gas bubbles into a reaction zone (3) containing molten salt and catalyst particles, wherein the catalyst particles are suspended in the molten salt;
(c) subjecting the methane-containing stream to catalytic pyrolysis in the reaction zone (3) thereby obtaining solid carbon and gaseous hydrogen;
(d) allowing the molten salt, solid carbon and gaseous hydrogen to move upwards from the reaction zone (3) to an intermediate zone (4) whilst catalyst particles are kept in the reaction zone (3);
(e) optionally, allowing a first part of the molten salt to flow from the intermediate zone (4) to the reaction zone (3), or from an upper part of the reaction zone (3) to a lower part of the reaction zone (3), via a return loop (6);
(f) allowing solid carbon, gaseous hydrogen and a second part of the molten salt to move further upwards from the intermediate zone (4) to a separation zone (5);
(g) removing solid carbon and gaseous hydrogen from the separation zone (5) by gas entrainment using an inverted funnel (9);
wherein gas bubbles are broken by first bubble breakers (7) having an open area of greater than 90% when the molten salt, solid carbon and gaseous hydrogen are moving upwards in step (d) from the reaction zone (3) to the intermediate zone (4); and
wherein gas bubbles are broken by second bubble breakers (8) when the molten salt, solid carbon and gaseous hydrogen are moving upwards in step (f) from the intermediate zone (4) to the separation zone (5).

2. The method according to claim 1, wherein the first and second bubble breakers (7,8) are in the form of vertically extending plates or filters.

3. The method according to claim 1, wherein the first bubble breakers (7) are fully submerged in molten salt.

4. The method according to claim 1, wherein the second bubble breakers (8) are only partially submerged in molten salt.

5. The method according to claim 1, wherein the second bubble breakers (8) have an open area of from 70 to 90%.

6. The method according to claim 1, wherein supplemental gas (30) is fed to the separation zone (5).

7. The method according to claim 1, wherein in step (g) solid carbon and gaseous hydrogen are removed from the separation zone (5) by a screw conveyor (12).

8. An apparatus (1) for catalytically pyrolyzing a methane-containing stream, the apparatus at least comprising:
a reaction zone (3) containing molten salt and catalyst particles, wherein during use a methane-containing stream (10) can be fed into the reaction zone (3) in the form of gas bubbles and the catalyst particles can be suspended in the molten salt, and wherein during use the methane-containing stream can be subjected to catalytic pyrolysis in the reaction zone (3) thereby obtaining solid carbon and gaseous hydrogen;
an intermediate zone (4) for receiving molten salt, solid carbon and gaseous hydrogen that during use have moved upwards from the reaction zone (3) to the intermediate zone (4) whilst catalyst particles are kept in the reaction zone (3);
optionally, a return loop (6) for allowing a first part of the molten salt to flow from the intermediate zone (4) to the reaction zone (3), or from an upper part of the reaction zone (3) to a lower part of the reaction zone (3);
a separation zone (5) for receiving solid carbon, gaseous hydrogen and a second part of the molten salt that have moved further upwards from the intermediate zone (4) to the separation zone (5), and for separating the solid carbon and gaseous hydrogen from the molten salt;
first bubble breakers (7) placed between the reaction zone (3) and the intermediate zone (4) that can break gas bubbles when the molten salt, solid carbon and gaseous hydrogen are moving upwards from the reaction zone (3) to the intermediate zone (4), the first bubble breakers (7) having an open area of greater than 90%;
second bubble breakers (8) placed between the intermediate zone (4) and the separation zone (5) that can break gas bubbles when the molten salt, solid carbon and gaseous hydrogen are moving upwards from the intermediate zone (4) to the separation zone (5);
a sucker (9) for removing solid carbon and gaseous hydrogen from the separation zone (5) by gas entrainment, using an inverted funnel.

9. The apparatus (1) according to claim 8, wherein the bubble breakers (7,8) are in the form of vertically extending plates or filters.

10. The apparatus according to claim wherein during use the first bubble breakers (7) are fully submerged in molten salt.

11. The apparatus according to claim 8, wherein during use the second bubble breakers (8) are only partially submerged in molten salt.

12. The apparatus according to claim 8, wherein the second bubble breakers have an open area of from 70 to 90%.

13. The apparatus (1) according to claim 8, wherein the separation zone (5) has an inlet (51) for feeding supplemental gas (30).

14. The apparatus (1) according to claim 1, wherein the apparatus (1) comprises a screw conveyor (12) for removing solid carbon and gaseous hydrogen from the separation zone (5).
